(19) United States
(12) Patent Application Publication
(10) Pub. No.: US 2024/0353966 A1
(43) Pub. Date: Oct. 24, 2024

(54) OPERATING TERMINAL, OPERATING METHOD, AND PROGRAM

(71) Applicant: NIPPON TELEGRAPH AND TELEPHONE CORPORATION, Tokyo (JP)

(72) Inventors: Yuki KUBO, Tokyo (JP); Ryosuke AOKI, Tokyo (JP); Yukio KOIKE, Tokyo (JP)

(21) Appl. No.: 18/571,366

(22) PCT Filed: Jul. 5, 2021
(86) PCT No.: PCT/JP2021/025313

§ 371 Date: Dec. 18, 2023

(51) Int. Cl. G06F 3/04883; G06F 3/041

(52) U.S. Cl. CPC G06F 3/04883; G06F 3/0412

(57) ABSTRACT

A user moves a cursor on a display of an operation terminal on the basis of a pressure change in X-axis and Y-axis directions, and performs a tap operation on the display on the basis of a pressure change in a Z-axis direction. However, in a case where the user performs a tap operation, not only a pressure in the X-axis and Y-axis directions but also a pressure in the Z-axis direction is applied, and erroneous measurement of a tap operation may occur.

Therefore, an operation terminal 1 measures a first pressure value indicating a pressure in a first parallel direction with respect to a touch surface of a touch sensor such as a touch panel, a second pressure value indicating a pressure in a second parallel direction with respect to the touch surface, and a third pressure value indicating a pressure in a vertical direction with respect to the touch surface, measures a predetermined pressure duration indicating a time during which the third pressure value continues to be within a predetermined pressure value range, and determines that an operation on the touch sensor is a tap operation in a case where the predetermined pressure duration is equal to or less than a predetermined time or is less than a predetermined time and a maximum value of the first pressure value and a maximum value of the second pressure value measured within the predetermined pressure duration are equal to or smaller than a predetermined value or are smaller than a predetermined value.

### TECHNICAL FIELD

The present disclosure relates to an operation terminal, an operation method, and a program.

### BACKGROUND ART

An operation terminal such as a smartphone is equipped with a display for display and a touch panel for inputting an operation from a user. In addition, a triaxial pressure sensor is used for the touch panel. Therefore, the operation terminal measures a pressure value in a lateral direction (X-axis direction) with respect to a surface of the touch panel, a pressure value in a longitudinal direction (Y-axis direction) with respect to the surface of the touch panel, and a pressure value in a vertical direction (Z-axis direction) with respect to the surface of the touch panel, on the basis of a user's operation on the touch panel (see Non Patent Literature 1).

As a result, the user can move a cursor on the display on the basis of a pressure change in the X-axis and Y-axis directions, and perform a cursor determination operation (tap operation) on the display on the basis of a pressure change in the Z-axis direction.

### CITATION LIST

### Non Patent Literature

Non Patent Literature 1: Jun Rekimoto and Carsten Schewsig, PreSenseII: Bi-directional Touch and Pressure Sensing Interactions with Tactile Feedback, CHI 2006 extended abstracts on Human factors in computing systems, pp. 1253-1258, 2006.

### SUMMARY OF INVENTION

### Technical Problem

However, in a case where the user performs a tap operation, not only a pressure in the X-axis and Y-axis directions but also a pressure in the Z-axis direction is applied due to the characteristics of the triaxial pressure sensor, and thus erroneous measurement of a tap operation may occur.

The present invention has been made in view of the above points, and an object thereof is to more accurately determine a tap operation in a case where a user operates a touch sensor such as a touch panel in an operation terminal.

### Solution to Problem

In order to solve the above problem, an invention according to claim 1 is an operation terminal including: a touch sensor; a measurement means that measures a first pressure value indicating a pressure in a first parallel direction with respect to a touch surface of the touch sensor, a second pressure value indicating a pressure in a second parallel direction with respect to the touch surface, and a third pressure value indicating a pressure in a vertical direction with respect to the touch surface; a pressure value fluctuation time measurement means that measures a predetermined pressure duration indicating a time during which the third pressure value continues to be within a predetermined pressure value range; and an operation determination means that determines that an operation on the touch sensor is a tap operation in a case where a condition that the predetermined pressure duration is equal to or less than a predetermined time or is less than a predetermined time and a maximum value of the first pressure value and a maximum value of the second pressure value measured within the predetermined pressure duration are equal to or smaller than a predetermined value or are smaller than a predetermined value is satisfied.

### Advantageous Effects of Invention

As described above, according to the present invention, in a case where a user operates a touch sensor in an operation terminal, the operation terminal can more accurately determine a tap operation.

### BRIEF DESCRIPTION OF DRAWINGS

FIG. 1 is an external view of a smartphone.

FIG. 2 is an electrical hardware configuration diagram of the smartphone.

FIG. 3 is a cross-sectional view of an operation panel.

FIG. 4 is a functional configuration diagram of the smartphone.

FIG. 5 is a flowchart illustrating processing for a user operation.

FIG. 6 is a flowchart illustrating the processing for a user operation.

FIG. 7 is a diagram illustrating a relationship between a pressure value in a Z-axis direction and time.

FIG. 8 is a flowchart illustrating movement processing of a cursor.

FIG. 9 is a diagram illustrating a relationship between pressure in X-axis and Y-axis directions by pressing and the moving speed of the cursor.

### DESCRIPTION OF EMBODIMENTS

Hereinafter, an embodiment of the present invention will be described with reference to the drawings.

### [External Configuration]

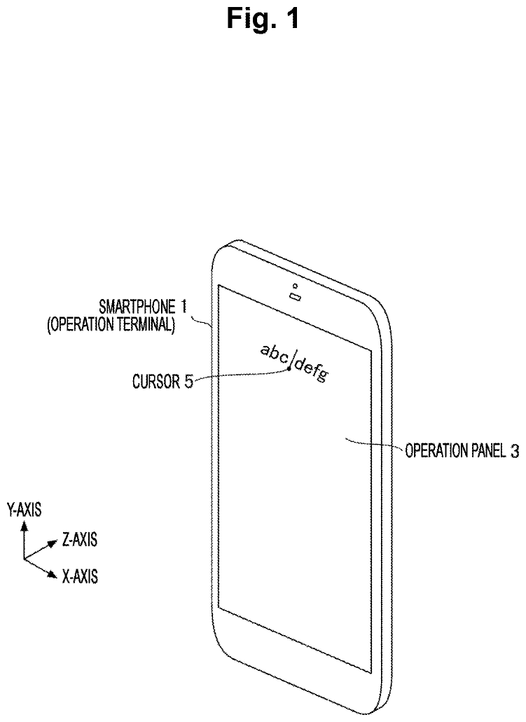

First, an external configuration of a smartphone of the present embodiment will be described with reference to FIG. 1. FIG. 1 is an external view of the smartphone according to the embodiment of the present invention. A smartphone 1 is an example of an operation terminal.

As illustrated in FIG. 1, the smartphone 1 of the present embodiment is provided with an operation panel 3. A cursor 5 is displayed on the operation panel 3 together with characters, symbols, images, and the like.

Furthermore, in FIG. 1, a lateral direction with respect to a surface of the operation panel 3 is an X-axis direction, a longitudinal direction with respect to the surface of the operation panel is a Y-axis direction, and a vertical direction with respect to the surface of the operation panel 3 is a Z-axis direction.

The smartphone 1 moves the cursor by sensor values (pressure values) in the X-axis and Y-axis directions and performs a tap operation by a sensor value (pressure value) in the Z-axis direction in response to a user's operation on a touch panel 310. Note that the touch panel is an example of a touch sensor. In the case of the touch sensor, the lateral direction and the longitudinal direction with respect to the surface of the touch sensor are a first parallel direction and a second parallel direction (or the second parallel direction and the first parallel direction) with respect to a touch surface of the touch sensor, respectively.

### [Hardware Configuration]

### <Hardware Configuration of Smartphone>

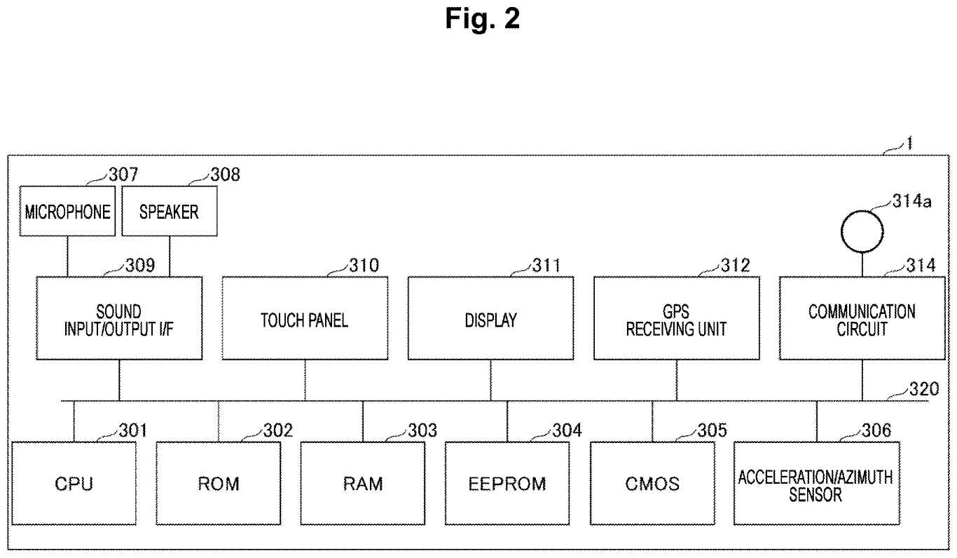

Next, an electrical hardware configuration of the smartphone 1 will be described with reference to FIG. 2. FIG. 2 is an electrical hardware configuration diagram of the smartphone.

As illustrated in FIG. 2, the smartphone 1 includes a CPU 301, a ROM 302, a RAM 303, an EEPROM 304, a CMOS sensor 305, and an acceleration/azimuth sensor 306.

Among the components, the CPU 301 controls the entire operation of the smartphone 1. The ROM 302 stores the CPU 301 and a program used for driving the CPU 301, such as IPL. The RAM 303 is used as a working area of the CPU 301. The EEPROM 304 reads or writes various data such as a smartphone program under the control of the CPU 301. The complementary metal oxide semiconductor (CMOS) sensor 305 is a type of built-in imaging means that images a subject or the like to obtain image data under the control of the CPU 301. Note that an imaging means such as a charge coupled device (CCD) sensor may be used instead of the CMOS sensor. The acceleration/azimuth sensor 306 includes various sensors such as an electronic magnetic compass or a gyro compass that detects terrestrial magnetism and an acceleration sensor.

In addition, the smartphone 1 includes a microphone 307, a speaker 308, a sound input/output I/F 309, the touch panel 310, a display 311, a GPS receiving unit 312, a communication circuit 314, and an antenna 314a of the communication circuit 314.

Among the components, the microphone 307 is a built-in circuit that converts sound into an electric signal. The speaker 308 is a built-in circuit that converts an electric signal into physical vibration to generate sound such as music or voice. The sound input/output I/F 309 is a circuit that processes an input and an output of a sound signal between the microphone 307 and the speaker 308 under the control of the CPU 301. The touch panel 310 is a type of input means that operates the smartphone 1 by being pressed by the user. The display 311 is a type of display means such as liquid crystal or organic electro luminescence (EL) that displays an image of a subject, various icons, and the like. The GPS receiving unit 312 receives a GPS signal from a GPS satellite. The communication circuit 314 is a circuit that communicates with another device and a server via a communication network such as the Internet or a local area network (LAN) using the antenna 314a.

In addition, the smartphone 1 includes a bus line 320. The bus line 320 is an address bus, a data bus, or the like for electrically connecting each component such as the CPU 301 illustrated in FIG. 2.

### <Configuration of Operation Panel>

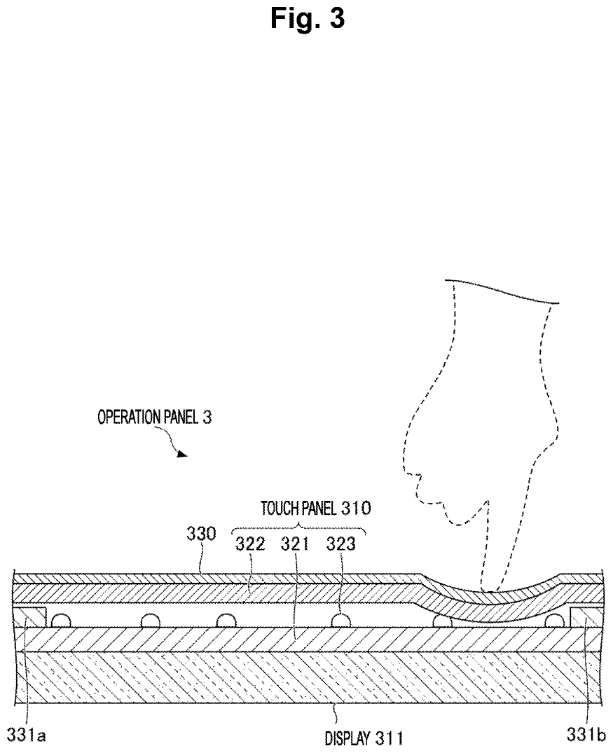

Next, a configuration of the operation panel will be described with reference to FIG. 3. FIG. 3 is a cross-sectional view of the operation panel. Note that the configuration illustrated in FIG. 3 is an example, and the operation panel may not have such a configuration.

As illustrated in FIG. 3, the operation panel 3 is roughly divided into the touch panel 310 and the display 311.

The touch panel 310 is laminated on a display surface of the display 311. The touch panel 310 is formed in a laterally long rectangular flat plate shape having the same size as the display 311. The touch panel 310 is a resistance film type touch sensor including a first resistance film 321, a second resistance film 322, and dot spacers 323. Each of the first resistance film 321, the second resistance film 322, and the dot spacers 323 is formed of a transparent member.

The first resistance film 321 is adhered and closely attached to the display surface of the display 311. The dot spacers 323 are provided on the other surface of the first resistance film 321 opposite to the surface closely attached to the display 311. The dot spacers 323 are provided in plurality on the first resistance film 321.

In addition, the second resistance film 322 is arranged to face the other surface of the first resistance film 321, on which the dot spacers 323 are provided, with a space. The second resistance film 322 is formed of a flexible member.

Furthermore, a flexible protective film 330 is laminated on the other surface of the second resistance film 322 opposite to the surface facing the first resistance film 321. The second resistance film 322 is protected by the protective film 330.

Furthermore, insulating layers 331a and 331b are arranged between the first resistance film 321 and the second resistance film 322.

With such a configuration, the second resistance film 322 is pressed by a finger of a person or a touch pen via the protective film 330, and the second resistance film 322 and the first resistance film 321 are brought into contact with each other, whereby the touch panel 310 detects an input position (coordinates).

### [Functional Configuration of Smartphone]

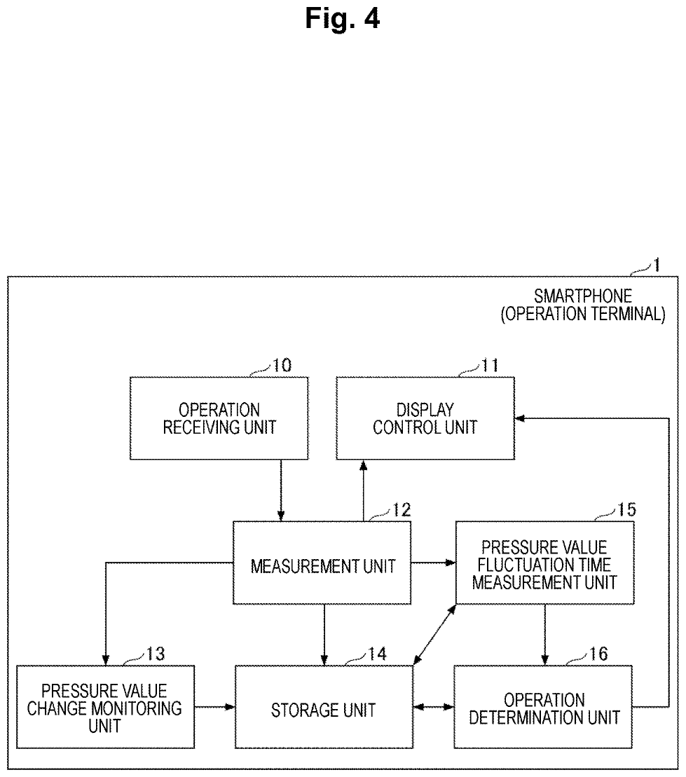

Next, a functional configuration of the smartphone will be described with reference to FIG. 4. FIG. 4 is a functional configuration diagram of the smartphone according to the embodiment of the present invention.

In FIG. 4, the smartphone 1 includes an operation receiving unit 10, a display control unit 11, a measurement unit 12, a pressure value change monitoring unit 13, a pressure value fluctuation time measurement unit 15, and an operation determination unit 16. Each of these units is a function achieved by a command by the CPU 301 in FIG. 2 on the basis of a program. Furthermore, the smartphone 1 includes a storage unit 14 implemented by the RAM 303 or the HD 304 in FIG. 2.

### <Functional Configuration>

Next, each functional configuration of the smartphone will be described with reference to FIG. 4.

The operation receiving unit 10 receives an operation by a user via the touch panel 310. In this case, the operation receiving unit 10 acquires, from the touch panel 310, data of a position (coordinates) detected by the touch panel 310.

The display control unit 11 displays characters, symbols, videos (images), and the like on the display 311, and displays the cursor 5.

The measurement unit 12 measures pressure values indicating pressures in three axial directions (X-axis, Y-axis, and Z-axis directions) with respect to a surface of the touch panel 310. The pressure values in the three axial directions are a pressure value Fx (first pressure value) indicating a pressure in the lateral direction with respect to the surface of the touch panel 310, a pressure value Fy (second pressure value) indicating a pressure in the longitudinal direction with respect to the surface of the touch panel 310, and a pressure value Fz indicating a pressure in the vertical direction with respect to the surface of the touch panel 310.

The pressure value change monitoring unit 13 determines whether the pressure value Fz measured by the measurement unit 12 is equal to or larger than a pressure threshold value Fs that has already been set.

The storage unit 14 stores pressure values indicated by sensor values in the Z-axis direction for a predetermined number of past frames related to the sensor value that is equal to or larger than the pressure threshold value Fs.

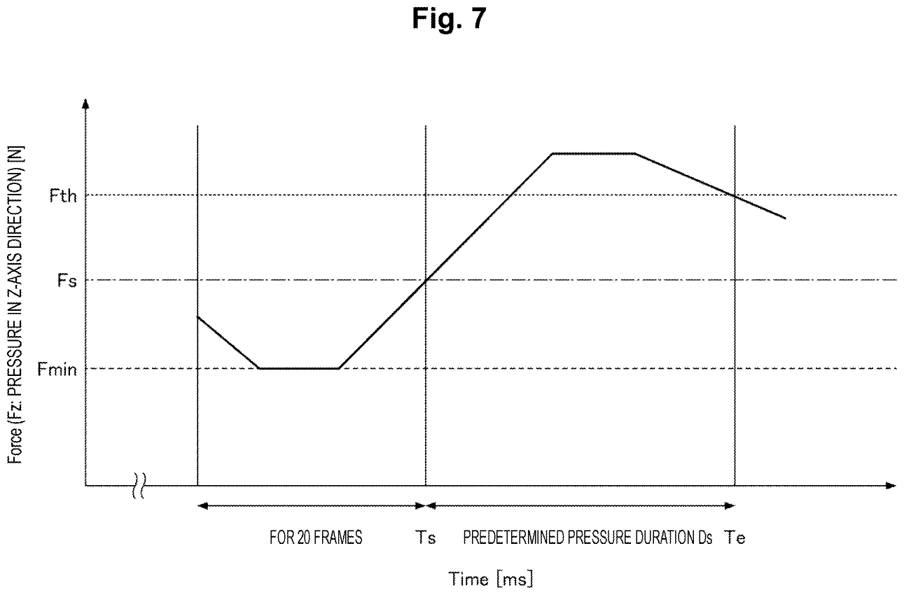

The pressure value fluctuation time measurement unit 15 measures a predetermined pressure duration Ds indicating a time during which the pressure value Fz continues to be within a predetermined pressure value range (see FIG. 7). Furthermore, the pressure value fluctuation time measurement unit 15 sets, as a start point Ts of the predetermined pressure duration Ds, a time point at which the pressure value Fz becomes equal to or larger than the first threshold value Fs as the predetermined pressure value range (see FIG. 7). Furthermore, the pressure value fluctuation time measurement unit 15 sets, as an end point Te of the predetermined pressure duration Ds, a time point at which the pressure value Fz becomes smaller than a second threshold value Fth, which is larger than the first threshold value Fs, as the predetermined pressure value range (see FIG. 7).

The operation determination unit 16 determines that an operation on the operation panel 3 (touch panel 310) is a tap operation in a case where a condition that the predetermined pressure duration is equal to or less than a predetermined time and maximum values of the pressure values Fx and Fy measured within the predetermined pressure duration Ds are equal to or smaller than a predetermined value is satisfied. Furthermore, the operation determination unit 16 determines that an operation on the operation panel 3 (touch panel 310) is a cursor moving operation in a case where the condition that the maximum values of the pressure values Fx and Fy are equal to or smaller than the predetermined value is not satisfied.

### [Processing or Operation of Embodiment]

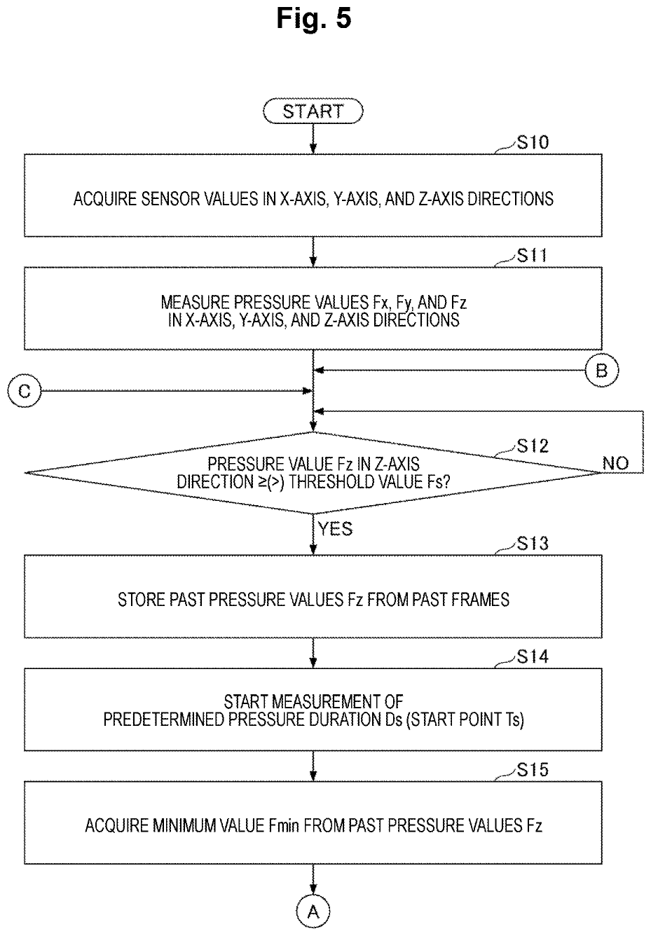

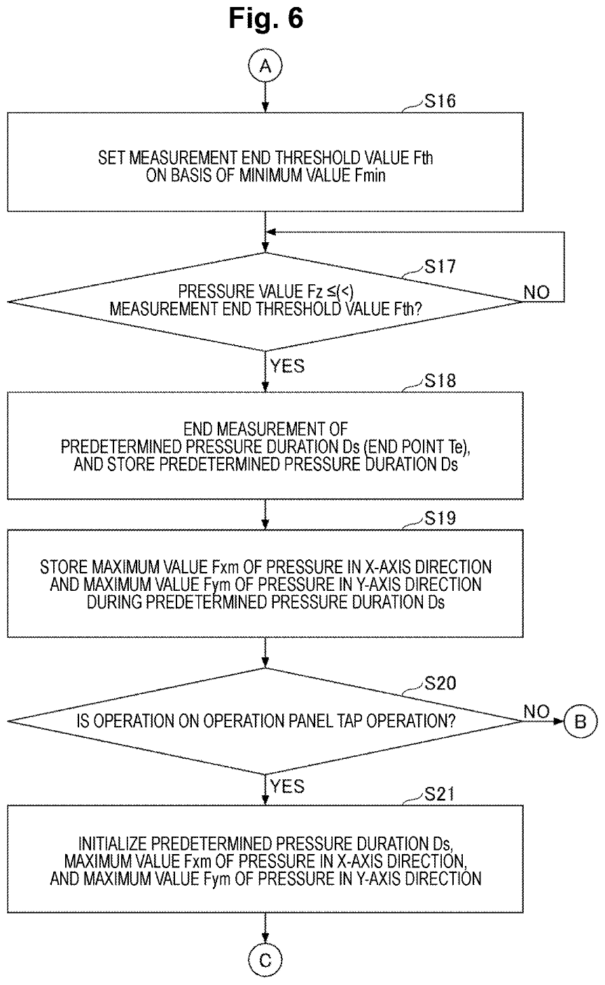

Next, processing or operation of the present embodiment will be described in detail with reference to FIGS. 5 to 9. FIGS. 5 and 6 are flowcharts illustrating processing for a user operation.

First, as illustrated in FIG. 1, the display control unit 11 displays the cursor 5 on the operation panel 3 (display 311). When the user performs an operation on the operation panel 3 (touch panel 310), the operation receiving unit 10 receives the user's operation, and the measurement unit 12 acquires sensor values in the X-axis, Y-axis, and Z-axis directions from the operation receiving unit 10 (S10). The measurement unit 12 then measures the pressure value Fx in the X-axis direction, the pressure value Fy in the Y-axis direction, and the pressure value Fz in the Z-axis direction on the basis of the sensor values (S11).

Next, the pressure value change monitoring unit 13 determines whether the pressure value Fz measured in step S11 is equal to or larger than the pressure threshold value Fs that has already been set (S12). For example, the threshold value Fs in this case is 0.8 [N]. Note that it may be determined whether the value “exceeds” the threshold value instead of the determination as to whether the value is “equal to or larger than” the threshold value.

Next, in a case where the pressure value Fz is equal to or larger than the pressure threshold value Fs in step S12 (step S12; YES), the pressure value change monitoring unit 13 stores, in the storage unit 14, pressure values indicated by sensor values in the Z-axis direction for a predetermined number of past frames related to the sensor value that is equal to or larger than the pressure threshold value Fs (S13). For example, the number of past frames is 20. The number of 20 frames is illustrated in FIG. 7. FIG. 7 is a diagram illustrating a relationship between the pressure value in the Z-axis direction and time. Note that the pressure values stored in the storage unit 14 are not limited to the values for past 20 frames, but may have any number as long as pressure values for one frame or more are stored.

In addition, the past frames are acquired at 30 frames per second (fps), for example, by the touch panel 310 and include pressure values in three axes of X, Y, and Z. A predetermined number (for example, 100) of past frames are overwritten and stored in the storage unit 14.

Note that, in step S12 described above, in a case where the pressure value Fz is not equal to or larger than the pressure threshold value Fs (smaller than the pressure threshold value Fs) (S12; NO), the processing of step S12 is repeated.

Next, the pressure value fluctuation time measurement unit 15 starts measurement of the predetermined pressure duration Ds, which is a time until the pressure value Fz becomes equal to or smaller than the measurement end threshold value Fth to be described later (S14). The start time point (start point) of this predetermined pressure duration Ds is Ts in FIG. 7.

Next, in a case where the pressure value fluctuation time measurement unit 15 starts the measurement of the predetermined pressure duration Ds in step S14, the pressure value fluctuation time measurement unit 15 acquires a minimum value Fmin of the pressure in the Z-axis direction from the past frames (20 frames) stored in the storage unit 14 (S15).

Next, in FIG. 6, the pressure value fluctuation time measurement unit 15 sets the measurement end threshold value Fth of the pressure in the Z-axis direction, which is a condition for ending the time measurement started in step S14 described above, on the basis of the minimum value Fmin acquired in step S15 described above (S16). The threshold value of the end condition is, for example, as follows, but these may be arbitrarily designated.

$$Fth = Fs + 0.25 [ N ] ( F min \geq 0 )$$

$$Fth = 0.25 [ N ] ( F min < 0 )$$

Note that, at the time of operation by the user, the touch panel 310 may detect a force in the negative direction depending on the way of applying the force, and the threshold value in the case of (Fmin<0) is set in order to prevent a processing error due to the detection of a force in the negative direction.

Next, the pressure value fluctuation time measurement unit 15 determines whether the pressure value Fz in the Z-axis direction indicated by the current sensor value acquired from the measurement unit 12 becomes equal to or smaller than the measurement end threshold value Fth set in step S16 (S17). Note that it may be determined whether the value is “smaller than” the threshold value instead of the determination as to whether the value is “equal to or smaller than” the threshold value.

When the pressure value Fz becomes equal to or smaller than the measurement end threshold value Fth (step S17; YES), the pressure value fluctuation time measurement unit 15 ends the measurement started in step S14, and stores data indicating the predetermined pressure duration Ds (see FIG. 7), which is a time from the start point Ts of the measurement to the end point Te, in the storage unit 14 (S18). Note that, when the pressure value Fz exceeds the measurement end threshold value Fth (S17; NO), the processing of step S17 is continued.

Next, the storage unit 14 stores a maximum value Fxm of the pressure indicated by the sensor value in the X-axis direction and a maximum value Fym of the pressure indicated by the sensor value in the Y-axis direction obtained from the measurement unit 12 as needed during the predetermined pressure duration Ds related to the pressure in the Z-axis direction (S19). Note that, when the maximum value Fxm or the maximum value Fym is updated during the predetermined pressure duration Ds, the updated maximum value is overwritten and stored each time.

Next, the operation determination unit 16 determines whether the operation by the user is a tap operation, using the predetermined pressure duration Ds recorded in step S17 and the maximum value Fxm of the pressure in the X-axis direction and the maximum value Fym of the pressure in the Y-axis direction stored in step S19 (S20). The operation determination unit 16 determines that the operation by the user is a tap operation in a case where the following conditional expressions are satisfied, but these may be different values or expressions, and the forms thereof are not limited.

Fxm<0.5 [N], Fym<0.5 [N], 50 (ms)<=Ds<=140 (ms)

Next, in a case where the operation by the user is a tap operation in step S20 described above (step S20; YES), the storage unit 14 initializes the maximum value Fxm of the pressure in the X-axis direction and the maximum value Fym of the pressure in the Y-axis direction, and further initializes the predetermined pressure duration Ds (S21). Thereafter, the processing returns to step S12 in the pressure value change monitoring unit 13, and the processing is continued. On the other hand, in a case where the operation by the user is not a tap operation in step S20 described above (step S20; NO), the processing does not proceed to step S21, but returns to step S12 in the pressure value change monitoring unit 13, and the processing is continued.

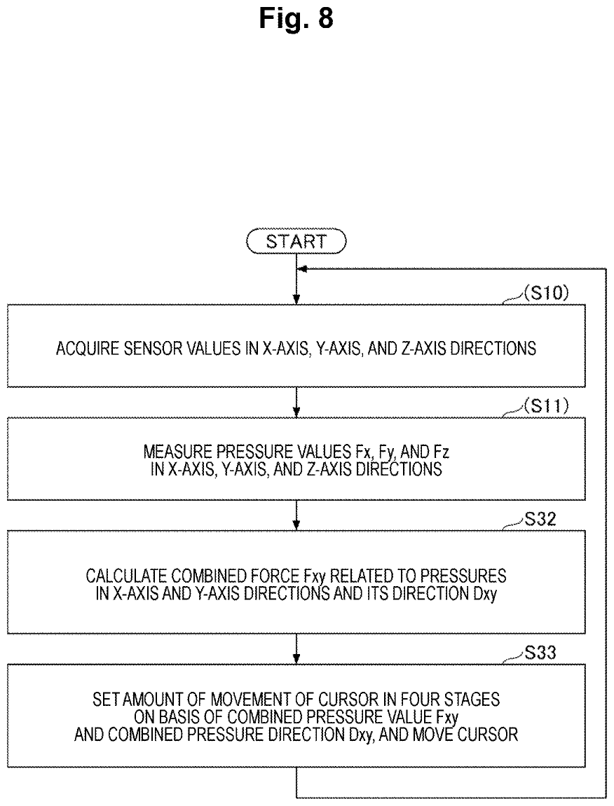

Meanwhile, in the above-described processing, the pressure indicated by the sensor value in the Z-axis direction has been mainly described. However, the sensor values in the X-axis direction and the Y-axis direction are also measured at the same timing and are related to the display position of the cursor 5. Therefore, each pressure in the X-axis direction and the Y-axis direction will be described with reference to FIG. 8.

After steps S10 and S11, the measurement unit 12 calculates a combined pressure value Fxy and a combined pressure direction Dxy from the sensor value in the X-axis direction and the sensor value in the Y-axis direction in parallel with the processing of steps S10 to S21 described above (S32). The display control unit 11 then performs processing of moving the cursor on the display 311 from the current display position (Px, Py) to the display position (Px+1, Py+1) on the basis of the combined pressure value Fxy and the combined pressure direction Dxy (degrees) (S33). Note that, here, the amount of movement of the cursor 5 is set in four stages, but may be in any number of stages.

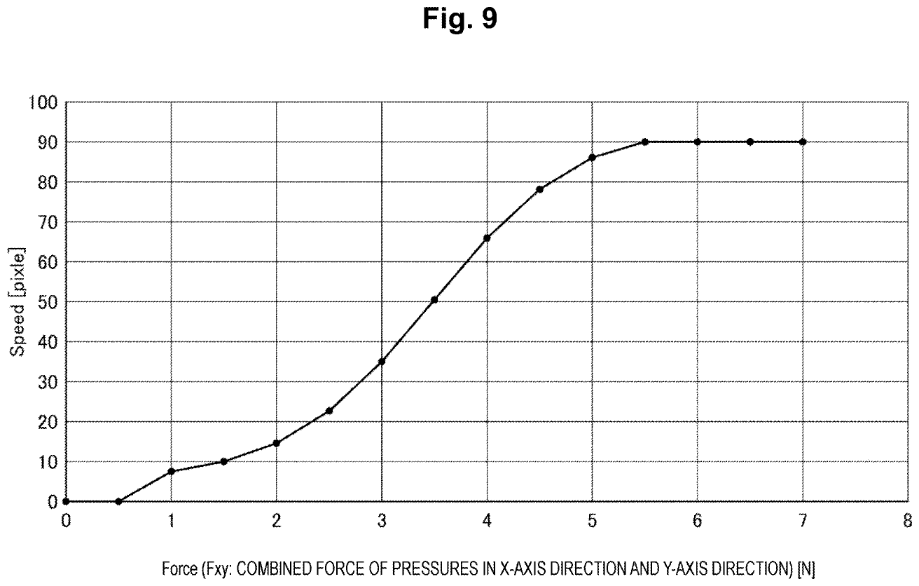

The movement of the cursor in this case is as shown in the following expressions in four cases and FIG. 9, but these expressions and values can be arbitrarily set, and the forms thereof are not limited. Note that FIG. 9 is a diagram illustrating a relationship between the pressure in the X-axis and Y-axis directions by pressing and the moving speed of the cursor.

$$[ 1 ] In the case of Fxy < 0.5 [ N ]$$

$$Px + 1 = Px + 1 ,$$

$$Py + 1 = Py$$

$$[ 2 ] In the case of 0.5 \leq Fxy < 1 [ N ]$$

$$Px + 1 = Px + ( 14.926754418 * Fxy * cos ( Dxy ) - 7.463377209 ) ,$$

$$Py + 1 = Py + ( 14.926754418 * Fxy * sin ( Dxy ) - 7.463377209 ) ,$$

$$[ 3 ] In the case of 1 \leq Fxy < 5.5 [ N ]$$

$$Px + 1 = Px + ( 90.396609 / ( 1 + exp ( - 1.1427768 * ( Fxy - 3.491156 ) ) + 4.955891 ) ) * cos ( Dxy ) ,$$

$$Px + 1 = Py + ( 90.396609 / ( 1 + exp ( - 1.1427768 * ( Fxy - 3.491156 ) ) + 4.955891 ) ) * sin ( Dxy ) ,$$

$$[ 4 ] In the case of 5.5 [ N ] \leq Fxy$$

$$Px + 1 = Px + 90 * cos ( Dxy ) ,$$

$$Py + 1 = Py + 90 * sin ( Dxy )$$

After the processing of step S33, the processing returns to the processing of step S10 again, and this series of processing is repeated until the program ends.

### Effects of Embodiment

As described above, according to the present embodiment, in a case where the user operates the operation panel 3 of the smartphone 1, the smartphone 1 can more accurately determine whether an operation is a tap operation or a cursor moving operation.

### [Supplement]

The present invention is not limited to the above-described embodiment, and may be configured or processed (operated) as described below.

(1) The smartphone 1 of the present invention can also be implemented by a computer and a program, and the program can be recorded in a recording medium or provided through a communication network.

(2) In the above embodiment, the smartphone 1 is shown as an example of an operation terminal, but the operation terminal is not limited thereto. For example, the operation terminal may be a tablet personal computer, a smartwatch, a notebook computer, a game device, a game device controller, a wearable device (such as a ring-type controller), a car navigation device, or the like.

(3) In the above embodiment, the touch panel has been described as an example of a touch sensor, but the touch sensor is not limited thereto. For example, the touch sensor may be a pointing stick provided substantially at the center of a keyboard or a touch pad provided in front of a keyboard of a notebook computer.

(4) The CPU 301 may be not only a single CPU but also a plurality of CPUS.

(5) In the processing of the pressure value fluctuation time measurement unit 15, a neural network may be used.

### REFERENCE SIGNS LIST

1 Smartphone (example of operation terminal)
3 Operation panel
5 Cursor
10 Operation receiving unit
11 Display control unit
12 Measurement unit (example of measurement means)
13 Pressure value change monitoring unit (example of pressure value change monitoring means)
14 Storage unit (example of storage means)
15 Pressure value fluctuation time measurement unit (example of pressure value fluctuation time measurement means)
16 Operation determination unit (example of operation determination means)
310 Touch panel (example of touch sensor)
311 Display

1. An operation terminal comprising:
a touch sensor; and
a hardware processor configured to
measure a first pressure value indicating a pressure in a first parallel direction with respect to a touch surface of the touch sensor, a second pressure value indicating a pressure in a second parallel direction with respect to the touch surface, and a third pressure value indicating a pressure in a vertical direction with respect to the touch surface;
measure a predetermined pressure duration indicating a time during which the third pressure value continues to be within a predetermined pressure value range; and
determine that an operation on the touch sensor is a tap operation in a case where a condition that the predetermined pressure duration is equal to or less than a predetermined time or is less than a predetermined time and a maximum value of the first pressure value and a maximum value of the second pressure value measured within the predetermined pressure duration are equal to or smaller than a predetermined value or are smaller than a predetermined value is satisfied.

2. The operation terminal according to claim 1, wherein the hardware processor is configured to determine that the operation on the touch sensor is a cursor moving operation in a case where the condition is not satisfied.

3. The operation terminal according to claim 1, wherein the hardware processor is configured to set, as a start point of the predetermined pressure duration, a time point at which the third pressure value becomes equal to or larger than a first threshold value as the predetermined pressure value range.

4. The operation terminal according to claim 3, wherein the hardware processor is configured to set, as an end point of the predetermined pressure duration, a time point at which the third pressure value becomes smaller than a second threshold value, which is larger than the first threshold value, as the predetermined pressure value range.

5. The operation terminal according to claim 1, wherein the operation terminal is a smartphone, a tablet personal computer, a smartwatch, a notebook computer, a game device, a game device controller, a wearable device, or a car navigation device.

6. The operation terminal according to claim 1, wherein the hardware processor is configured to execute processing using a neural network.

7. An operation method executed by an operation terminal including a touch sensor, the operation method comprising:
measuring a first pressure value indicating a pressure in a first parallel direction with respect to a touch surface of the touch sensor, a second pressure value indicating a pressure in a second parallel direction with respect to the touch surface, and a third pressure value indicating a pressure in a vertical direction with respect to the touch surface;
measuring a predetermined pressure duration indicating a time during which the third pressure value continues to be within a predetermined pressure value range; and
determining that an operation on the touch sensor is a tap operation in a case where a condition that the predetermined pressure duration is equal to or less than a predetermined time or is less than a predetermined time and a maximum value of the first pressure value and a maximum value of the second pressure value measured within the predetermined pressure duration are equal to or smaller than a predetermined value or are smaller than a predetermined value is satisfied.

8. A non-transitory computer-readable recording medium storing a program for causing a computer to execute a process, the process comprising:
measuring a first pressure value indicating a pressure in a first parallel direction with respect to a touch surface of a touch sensor, a second pressure value indicating a pressure in a second parallel direction with respect to the touch surface, and a third pressure value indicating a pressure in a vertical direction with respect to the touch surface;
measuring a predetermined pressure duration indicating a time during which the third pressure value continues to be within a predetermined pressure value range; and
determining that an operation on the touch sensor is a tap operation in a case where a condition that the predetermined pressure duration is equal to or less than a predetermined time or is less than a predetermined time and a maximum value of the first pressure value and a maximum value of the second pressure value measured within the predetermined pressure duration are equal to or smaller than a predetermined value or are smaller than a predetermined value is satisfied.
